(19) United States
(12) Patent Application Publication
(10) Pub. No.: US 2018/0280121 A1
(43) Pub. Date: Oct. 4, 2018

(54) DENTAL IMPLANT SYSTEMS AND METHODS OF IMPLANTATION

(71) Applicant: ICO DENTAL, INC., Anaheim, CA (US)

(72) Inventors: Jiachang Zhang, Anaheim, CA (US); Chen-Yi Lin, Irvine, CA (US); Wen Yi Huang, Rowland Heights, CA (US)

(21) Appl. No.: 15/474,630

(22) Filed: Mar. 30, 2017

(51) Int. Cl. A61C 8/00; A61C 13/225

(52) U.S. Cl. CPC A61C 8/0068; A61C 13/2255

(57) ABSTRACT

Dental implant assemblies and methods of implanting the same ease and simplify implantation procedures while also reducing the risk of errors during implantation. One implant assembly includes a male-to-male connector to allow for use of a female locking nut that is larger than a typical locking screw during fixation of the dental implant. Another implant assembly combines use of the male-to-male connector with an abutment to improve alignment and fixation. Yet another implant assembly includes an adapter that surrounds the male-to-male connector to make the advancement of the dental implant to the implant site easier and more user-friendly. With such implant assemblies, dental prostheses can be more easily advanced and properly positioned at desired implant sites, while implantation processes are made safer and more simplified.

### BACKGROUND

### Field

The invention generally relates to dental implant systems and methods for securing one or more artificial teeth or dental prostheses to a bone of a patient. More specifically, the invention relates to dental implant assemblies and methods involving various implantable dental fixtures and components that can be used to more effectively secure dental prostheses to a maxilla or mandible of a patient, while also providing for a simpler and smoother implantation process.

### Description of Related Art

Referring first to FIG. 1, a top-view schematic profile of a jawline 800, for example, of a mandible or lower jawbone, is shown, including a number of teeth 810. In the example FIG. 1, various teeth 810 are missing individually and/or consecutively along the jawline 800. Teeth can be lost for various reasons, or may be damaged beyond repair, in which case a dentist or other dental professional may suggest extracting or removing the tooth and replacing the tooth with a tooth implant. In the example shown, a single molar 820 is missing, which can be replaced by a traditional single crown or dental implant (or in the case of the third molar or “wisdom tooth” shown, can be removed without being replaced). In another region of the jawline 800, two consecutive teeth 820 are missing (e.g., two consecutive bicuspids or premolars), and in yet another region of the jawline 800, four consecutive teeth are missing (e.g., two consecutive bicuspids or premolars, followed by two consecutive molars).

Meanwhile, while a lower jawline is illustrated, it is to be understood that similar ailments can also affect the maxilla or upper jawbone, and tooth loss or removal from the maxilla or the mandible can be treated in similar manners.

Single dental implant systems are widely used for replacing singular damaged or lost natural teeth, one at a time. Generally, in such systems, a dental fixture is first placed in the jawbone of a patient in order to serve as an anchor and replace the natural tooth root. Thereafter, additional dental components are connected to or interact with the dental fixture, and are further connected to a crown or other tooth-shaped prosthesis that serves as the exposed or functional portion of the replacement tooth.

In a first traditional implantation approach, schematically shown in FIG. 2, an abutment structure including one or several parts may be attached to the fixture in order to build up a core support structure for the part of the prosthetic tooth protruding from the bone, through the soft gingival tissue, and into the mouth cavity of the patient. In FIG. 2, a jaw region 1000 of a patient includes a jaw bone 1010 and gingival tissue 1020 that forms a gum line over the jaw bone 1010. One or more teeth 1030 are anchored in the jaw bone 1010, protrude through the gingival tissue 1020, and have exposed regions that extend into the mouth cavity and serve as the observable and functional portions of teeth 1030.

Here, one tooth has been lost or removed, forming a void between its two adjacent teeth 1030. A bore 1040 can be formed in the jaw bone 1010 at this position to anchor a dental implant 1100. The dental implant includes an anchoring fixture 1110, an abutment 1120, a screw 1130 for fixing the abutment 1120 to the fixture 1110, and a crown or exposed portion of the tooth prosthesis 1140. After a suitable bore 1040 has been formed, the anchoring fixture 1110 is securely implanted through the gingival tissue 1020 and into the jaw bone 1010. A top of the anchoring fixture 1110 can be substantially axially aligned with an exposed surface of the gingival tissue 1020. In some cases where bone material may be weak or deficient, a bone graft or membrane may need to be added to the implant site, to supplement or more securely anchor the fixture 1110. After the fixture 1110 has been implanted, there is generally a healing period for the fixture 1110 for healing and for the fixture 1110 to be fully integrated into the jaw bone 1010 naturally by the patient.

When the dentist or other dental professional determines that the fixture 1110 has been adequately set and integrated into the patient, an abutment 1120 can then be securely attached to the fixture 1110. The abutment 1120 generally includes a first distal portion that contacts the fixture 1110 and a second proximal portion that protrudes from the jaw line away from the fixture 1110. In general, the distal portion of the abutment 1120 includes a protrusion that interacts with a corresponding surface of the fixture 1110, so that the pieces can securely interlock with and be held against one another when assembled. In FIG. 2, the abutment 1120 has a short cylindrical portion that can be inserted into a cylindrical bore of the fixture 1110. Meanwhile, a proximal portion of the abutment 1120 includes a longer conical section that will protrude away from the fixture 1110 and out of the gingival tissue 1020, and is intended to interact with the crown 1140 when the pieces are assembled. The abutment 1120 further includes a bore with a shoulder at the distal end, and the fixture 1110 further includes a threaded bore that aligns axially with the bore of the abutment 1120 when the pieces are assembled together. A screw 1130 is used to connect and hold the fixture 1110 and the abutment 1120 together. The screw 1130 is sized to pass through the bore of the abutment 1120 and has a head that is sized to abut against the distal shoulder in the abutment 1120. Furthermore, the screw 1130 can be screwed into the threaded bore of the fixture 1110. When the screw 1130 is tightened in this fashion, the abutment 1120 is aligned and held in place against the fixture 1110.

After the abutment 1120 is secured to the fixture 1110, the tooth prosthesis or crown 1140 can then be attached to the proximal protruding portion of the abutment 1120. On one side, the crown 1140 includes a closed bore sized to fit over the proximal portion of the abutment 1120, and on an opposite side, the crown 1140 can be sized and shaped based on the particular tooth that is being replaced, for both aesthetic and functional purposes once the dental implant 1100 has been finally implanted. The prosthesis or crown 1140 may be permanently seated, adhered to, and secured to the proximal portion of the abutment 1120, for example, with cement.

However, a large number of dental implant failures are due to cement left behind after the surgical procedure. Excess cement subgingivally can also lead to peri-implantitis, which is a destructive inflammatory process affecting the soft and hard tissues surrounding dental implants. Therefore, in some instances, an alternative implantation procedure is preferred instead. In a second traditional implantation approach, schematically shown in FIG. 3, a screw-retained structure that generally includes several mechanically interlocking parts is used to secure the prosthesis or crown to the dental fixture, without the use of cement or other adhesive. Screw-retained implants are generally easier to maintain than the cement implants shown in FIG. 2. For example, screw-retained implants allow for retention (i.e., keeping abutments and implant crowns in place) and retrievability (i.e., allowing the implant-crown components to be more easily removed, repaired or replaced), without damaging the implant or the restoration. Many dental implants need to be replaced or repaired periodically, and are generally easier to remove or re-tighten if attached with screws rather than with cement.

In the typical screw-retained implant 1200 shown in FIG. 3, an anchoring fixture 1210 similar to the fixture 1110 in FIG. 2 can first be implanted into a bore 1040 formed into the jaw bone 1010, and can be supplemented, for example, with bone graft if necessary, and then is allowed to set and integrate into the jaw bone 1010 over a period of time. The screw-retained implant 1200 does not include an abutment, and rather only further includes a tooth prosthesis or crown 1240, and a fixation screw 1230 to attach the crown 1240 to the fixture 1210. As a result, the fixture 1210 may also be slightly different than the fixture 1110 in that there is no corresponding recess or engagement structure that has to match a corresponding engagement structure of an abutment. Therefore, in these embodiments, a proximal end of the fixture 1210 may be flat or may have some other slightly inclined or other surface to facilitate proper alignment with the crown 1240 during implantation. The crown 1240 itself further includes a through bore with a distal shoulder to interact with the screw 1230. When the crown 1240 is positioned and rotated over the fixture 1210 to a desired orientation, the screw 1230 is inserted into the bore of the crown 1240 and screwed into the threaded bore of the fixture 1210, while the head of the screw 1230 pushes against the shoulder in the crown 1240 to lock the crown 1240 against the fixture 1210. In some instances, an additional step of filling the bore of the crown 1240, for example, with a cap, cement, or other filling, after the crown 1240 has been affixed to the fixture 1210, can be further performed, in order to conform the top surface of the crown 1240 with the surfaces of the surrounding teeth 1030.

While screw-retained implants like the implant 1200 described with respect to FIG. 3 are generally easier to adjust and remove than abutment and cement-based implants like the implant 1100 descried with respect to FIG. 2, implants with superstructures such as abutments and crowns with closed bores also have several advantages. For example, with cement-based implants, an additional cap or filling does not need to be used, since after implantation, the bore of the crown is not exposed to the outside. In addition, there is more flexibility in making the superstructures (e.g., the exposed portions) of the abutments and of the corresponding closed bores in their respective crowns different asymmetric shapes, which can facilitate a more accurate placement and rotational positioning of the crown. For example, with an additional abutment, the interface between the abutment and fixture can be designed so that the abutment can only be positioned in one way relative to the fixture. Then, the superstructure or exposed portion of the abutment can, for example, be sloped in one direction or have some other structural asymmetry. The bore of the crown can then also be formed with the same slope or structural asymmetry in a specific orientation, so that when the crown is placed on the abutment, the crown can only be fully seated on the abutment at a particular desired position and rotational orientation relative to the jawbone and the surrounding teeth.

A third way to replace lost or extracted teeth (not shown) is with a multi-tooth bridge or partial denture which “bridges” a gap in the teeth with one or more dummy teeth, referred to as a pontic, that is molded together with one or two crowns intended to attach to and cover one or more adjacent existing teeth or dental implants. Bridges can be used, for example, when the region of the jaw bone corresponding to the missing or extracted tooth is too weak or diseased to support an anchoring fixture. If one or more existing adjacent teeth are instead strong enough to support and attach the bridge, those tooth or teeth are referred to as abutment teeth, and their sizes and shapes are reduced to allow the crown to affix over and attach to them. Some additional steps, for example, reinforcing the abutment teeth with additional parts such as metal copings, crowns, or caps, to provide for a more secure attachment with the bridge, may also be employed. The bridge is then placed over the edentulous space, and can be attached to the abutment teeth, generally with cement. After implantation, the abutment teeth therefore support the pontic of the bridge, and the edentulous space or gap where the lost or extracted tooth or teeth was can be filled by the pontic, without an anchor actually being implanted at the location of the lost or extracted tooth or teeth.

Bridges can also be used where multiple teeth are missing or extracted, for example, at space 830 or 840 in FIG. 1, where rather than relying on natural abutment teeth, a prosthetic anchoring fixture and abutment is implanted at one or more spaces (e.g., at the two outermost positions in edentulous space 840), over which the crowns of the bridges can be placed and attached. For example, with respect to space 840, anchors can be placed at the spaces corresponding to the first bicuspid and the second molar, and a four tooth bridge can be formed, and attached to those two anchors, while the second bicuspid and first molar can also be replaced without any fixtures at those positions. Meanwhile, in other examples, based on the particular situation and needs of the patient, anchors can be placed at more than just the ends of the edentulous space, in order to provide more support to the prosthesis. In yet other circumstances, a multi-tooth edentulous space can instead still be filled using single individual prosthetic implants at each individual tooth space. In these situations, either cement-based or screw-based implants can be used exclusively, or a combination of the two can also be used, depending for example, on the situation and the condition of the implant site.

### SUMMARY

Many issues can arise with the above described traditional dental implants, and in many instances, implantation procedures are prone to human error. For example, the dentist or dental professional usually receives the pieces associated with a dental implant as separate parts to be assembled in the oral cavity of the patient. While the end user who receives the various parts of the dental implant should understand how the pieces fit together, for example, how the abutment should be rotationally oriented relative to the fixture in order to obtain the desired alignment, it may still sometimes be difficult for the end user to see or determine what the correct orientation is during implantation. In other situations, there is also a risk of the end user overlooking or ignoring the correct rotational orientation of the implantable pieces altogether. Furthermore, the pieces associated with typical implants, especially the screw pieces, are generally very small and difficult to handle and advance to the implant site, where a minor mishandling of the fixation screw could result in the screw being lost, further adding to delays and complications in the implantation procedures.

Meanwhile, in situations with multi-tooth prostheses such as bridges, in addition to the above difficulties, the unitary nature of the bridge may present additional difficulties, for example, in placement, since single, large castings are susceptible to distortion during fabrication, causing less than optimal alignment of the copings or caps over the abutment teeth or implants. Even when casting distortions are avoided, simply properly aligning and inserting the prostheses over multiple abutment teeth or implanted abutments, which in some instances can only be slid into place at a certain configuration or angle, can be very difficult to accomplish. In addition, where a multi-tooth prosthetic or a full arch dental implant (i.e., a single casting of teeth that is used for replacing a full set of teeth along one of the patient's jawlines) is implanted, a large number of anchoring points may be needed. For example, a full arch dental implant often needs upwards of six or more anchoring points on the jawline in order to ensure secure implantation of the full arch. In these situations, some of the anchoring points may be difficult to access or advance a screw therein or apply cement thereto.

And even after a successful implantation, multi-tooth prostheses are subject to additional loads that can further damage the prosthetic and/or the abutment teeth or anchoring abutments. The unitary construction of the bridge subjects the abutment teeth or implanted abutments to considerable bending moments and stresses during pontic use (e.g., occlusal loadings during mastication applied to the abutment teeth or implants), which could result in a breakdown of the abutment teeth or implants, or a detachment of the bridge from the abutments. When such damage occurs, cutting through the cement to repair the bridge can be painful, costly, and time-consuming for the patient, while also being tedious and difficult for the dentist.

Embodiments of the invention provide dental implant systems and methods that address the above issues, among others. The dental implant systems and methods reduce the occurrence of implantation of dental prostheses at undesired or unintended positions or rotational orientations, and use of larger parts will provide for easier implantation and reduce the possibility of unintentional loss of parts of the implant. Furthermore, in the case of multi-tooth prostheses, by reducing the number of abutments needed for alignment purposes, implants according to embodiments of the invention can be advanced to implant sites from a wider area and from a greater range of angles, and positioning can thereafter be adjusted more easily at the implant sites. Such implants and methods can also provide for more secure implantation of the prostheses, with a reduced possibility of damage or disengagement from the implant site. These implants and easier implantation procedures can further result in shorter implantation procedures, reductions in cost, as well as stronger and safer implants.

According to an embodiment of the invention, a dental implant assembly includes a first fixation assembly including a male-to-male connector and a female locking nut, a second fixation assembly including an abutment, and a dental prosthesis having a first bore sized to receive the female locking nut and a second bore sized to receive the abutment. At one end of the first bore, the dental prosthesis includes a shoulder defining an opening. A first threaded portion of the male-to-male connector is configured to fit through the opening. An outer width of the female locking nut is greater than an inner width of the opening, such that the shoulder is configured to be locked between the first threaded portion and the female locking nut when the first threaded portion is passed through the opening into the first bore and the female locking nut engages the first threaded portion.

According to another embodiment of the invention, a method of implanting a dental implant assembly including a first fixation assembly including a male-to-male connector and a female locking nut configured to engage a first threaded portion of the male-to-male connector, a second fixation assembly including an abutment, and a dental prosthesis having a first bore configured to engage the male-to-male connector and sized to receive the female locking nut and a second bore sized to receive the abutment, includes implanting the male-to-male connector at a first position at an implant site, implanting the abutment at a second position at the implant site, positioning the dental prosthesis at the implant site such that the first bore is aligned with the male-to-male connector and the second bore is aligned with the abutment, and inserting the female locking nut into the first bore and engaging the female locking nut with the first threaded portion of the male-to-male connector for locking the dental prosthesis at the implant site.

According to yet another embodiment of the invention, a dental implant assembly includes an anchoring fixture for anchoring to a jawbone of a patient, a male-to-male connector having a first threaded portion configured to connect to the anchoring fixture and a second threaded portion, an adapter separable from the anchoring fixture, wherein when the anchoring fixture, the male-to-male connector, and the adapter are connected to one another, the adapter extends circumferentially around the second threaded portion of the male-to-male connector in a radial direction with a radial gap therebetween, a dental prosthesis defining a bore, and a female locking nut insertable into the bore of the dental prosthesis and configured to extend into the radial gap to engage the second threaded portion of the male-to-male connector.

According to embodiments of the invention, dental implant assemblies and methods can be utilized to more safely and effectively secure dental prostheses to implant sites of patients, while also simplifying the implantation process and also reducing occurrences of user error, especially with respect to multi-tooth prostheses.

### BRIEF DESCRIPTION OF THE DRAWINGS

Further features and advantages of the invention will become apparent from the description of the embodiments by means of the accompanying drawings. In the drawings:

FIG. 1 shows a schematic top view of a lower jaw bone, including teeth and a number of examples of edentulous spaces where native or natural teeth have been lost or extracted, and prior to implantation of dental implants;

FIG. 2 shows a cross-sectional view schematically showing an example of a row of teeth, and an exploded view of a traditional individual cement-based dental implant;

FIG. 3 shows a cross-sectional view schematically showing an example of a row of teeth, and an exploded view of a traditional individual screw-based dental implant;

FIG. 4A shows a perspective view of a lower jawline with a two-tooth edentulous space, and a two-tooth dental prosthesis prior to implantation, and FIG. 4B shows an exploded cross-sectional view of a dental implant assembly according to a first embodiment of the invention that includes the dental implant of FIG. 4A;

FIG. 5 shows a cross-sectional view of the dental prosthesis according to the first embodiment;

FIG. 6 shows a perspective view of a first anchoring fixture according to the first embodiment;

FIG. 7 shows a side view of a male-to-male screw or connector configured to be used with the first anchoring fixture according to the first embodiment;

FIGS. 8A and 8B respectively show a perspective view and a cross-sectional view of a female fixation screw or nut according to the first embodiment;

FIG. 9A shows a cross-sectional view of an implant site of a patient after select components of the dental implant according to the first embodiment have been implanted and before attachment of the dental prosthesis, and FIG. 9B shows a cross-sectional view of the implant site after the dental prosthesis has been attached;

FIG. 10 is a flow chart showing an implantation procedure of the dental implant assembly according to the first embodiment;

FIG. 11 shows an exploded perspective view of a full arch dental implant assembly according to a second embodiment of the invention;

FIG. 12A shows a perspective view of a lower jawline of a patient after select components of the dental implant according to the second embodiment have been implanted and before attachment of the dental prosthesis, and FIG. 12B shows a perspective view of the lower jawline after the dental prosthesis has been attached;

FIG. 13 shows a cross-sectional view of a portion of the lower jawline after the dental prosthesis has been attached;

FIG. 14 shows a cross-sectional view of a lower jawline with one tooth missing or extracted, and an exploded cross-sectional view of a dental implant assembly according to a third embodiment of the invention;

FIGS. 15A to 15C respectively show a perspective view, a cross-sectional view, and a top view of an adapter of the dental implant according to the third embodiment;

FIG. 16A and 16B respectively show a perspective view and a cross-sectional view of a female fixation screw or nut according to the third embodiment;

FIG. 17A shows a cross-sectional view of an implant site of a patient after select components of the dental implant according to the third embodiment have been implanted and before attachment of the dental prosthesis, and FIG. 17B shows a cross-sectional view of the implant site after the dental prosthesis has been attached;

FIG. 18A shows a perspective view of a full arch dental implant assembly according to a fourth embodiment of the invention, prior to attaching the dental prosthesis; and

FIG. 18B shows a perspective view of a full arch dental implant assembly according to a fifth embodiment of the invention, prior to attaching the dental prosthesis.

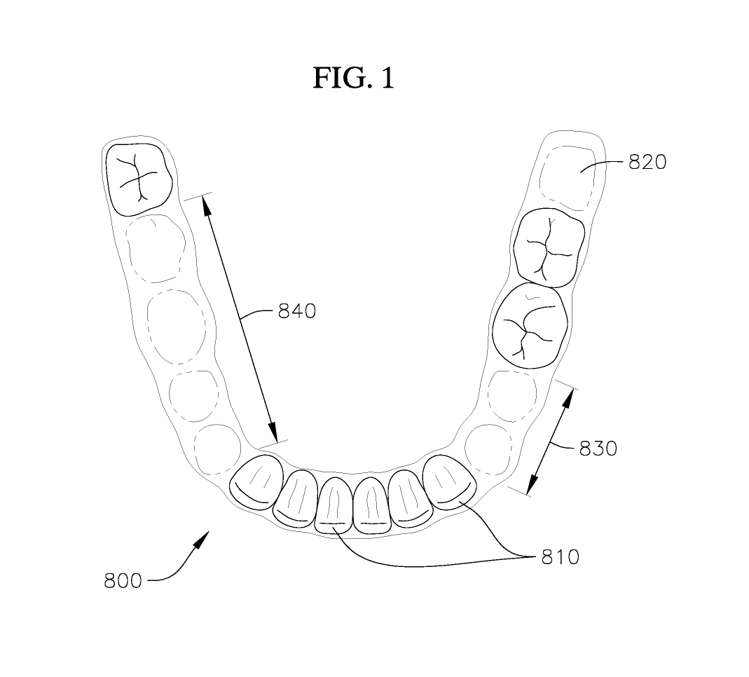

### DETAILED DESCRIPTION

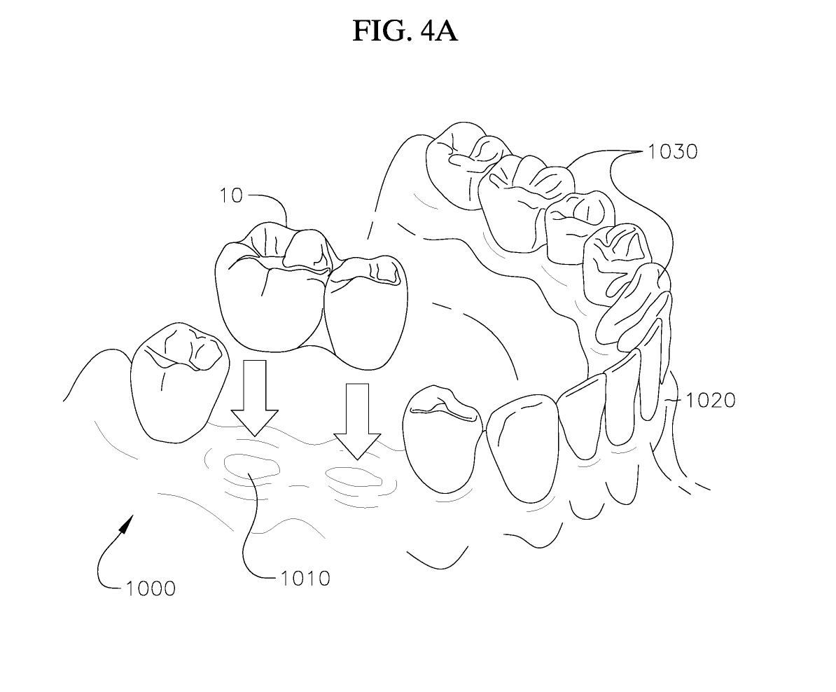

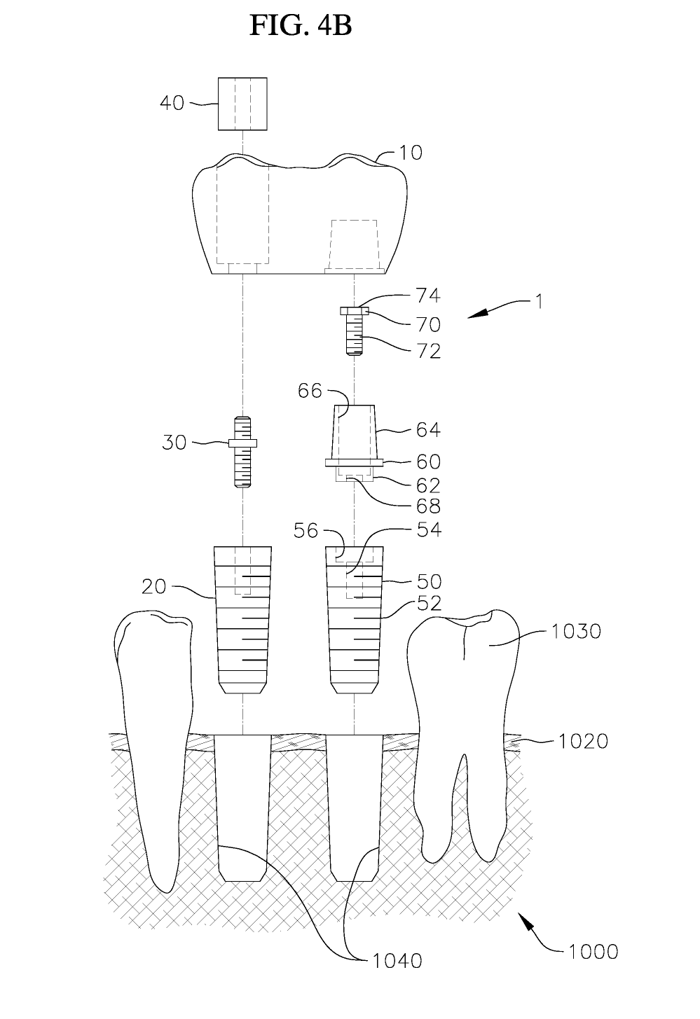

A dental implant assembly according to a first embodiment is shown in FIGS. 4A to 9. FIG. 4A shows a lower jawline 1000, where a mandible or lower jawbone 1010 is covered by gingival tissue 1020. Attached to the lower jawbone 1010 and protruding from the gingival tissue 1020 are a set of permanent teeth 1030. Meanwhile, an edentulous space spans two consecutive missing teeth, which can be for example, lost through decay or other causes, or extracted by a dental professional for replacement. In the example of FIG. 4A, the missing teeth are the second bicuspid and the first molar on the right side of the lower jawline 1000. In addition, a two-tooth dental prosthesis 10 is shown. The dental prosthesis 10 has been molded to replace the missing teeth shown. In other situations, other teeth may be missing on the lower jawline 1000, and dental implant assemblies according to embodiments of the invention can be modified and applied to the edentulous spaces based on the particular needs of the patient. The respective dental prostheses are formed corresponding to the amount of consecutive teeth to be replaced. For example, in cases where a single tooth is missing, a single tooth prosthetic can be prepared and implanted, and in cases where for example, four consecutive teeth are missing, a four-tooth prosthetic can be prepared and implanted. Additionally, it is to be understood that dental implant assemblies according to embodiments of the invention can also be applied to missing teeth at the upper jawline, similarly as described below with respect to the lower jawline.

FIG. 4B shows a cross-sectional view of the edentulous space in FIG. 4A. Furthermore, FIG. 4B includes an exploded cross-sectional view of a dental implant assembly 1 according to a first embodiment of the invention. The edentulous space includes two holes 1040 that may be prepared by a dental professional prior to implanting the dental implant assembly. For example, the holes 1040 can be sized for use as pilot holes that are enlarged via drilling into the jawbone 1010 in order to fit anchoring fixtures of the dental implant assembly 1, to be described in greater detail below. In some cases where the jawbone 1010 is diseased, decayed, or otherwise weakened, a bone graft or other supporting structure can also be added to the jawbone 1010 to better support the anchoring fixtures.

Meanwhile, the dental implant assembly 1 includes the two-tooth dental prosthesis 10 shown in FIG. 4A with two attachment regions corresponding respectively to the two holes 1040, a first part of the fixation assembly for one of the holes 1040, including a first anchoring fixture 20, a male-to-male screw or connector 30, and a female locking screw or nut 40, and a second part of the fixation assembly for the other one of the holes 1040, including a second anchoring fixture 50, an abutment 60, and a fixation screw 70.

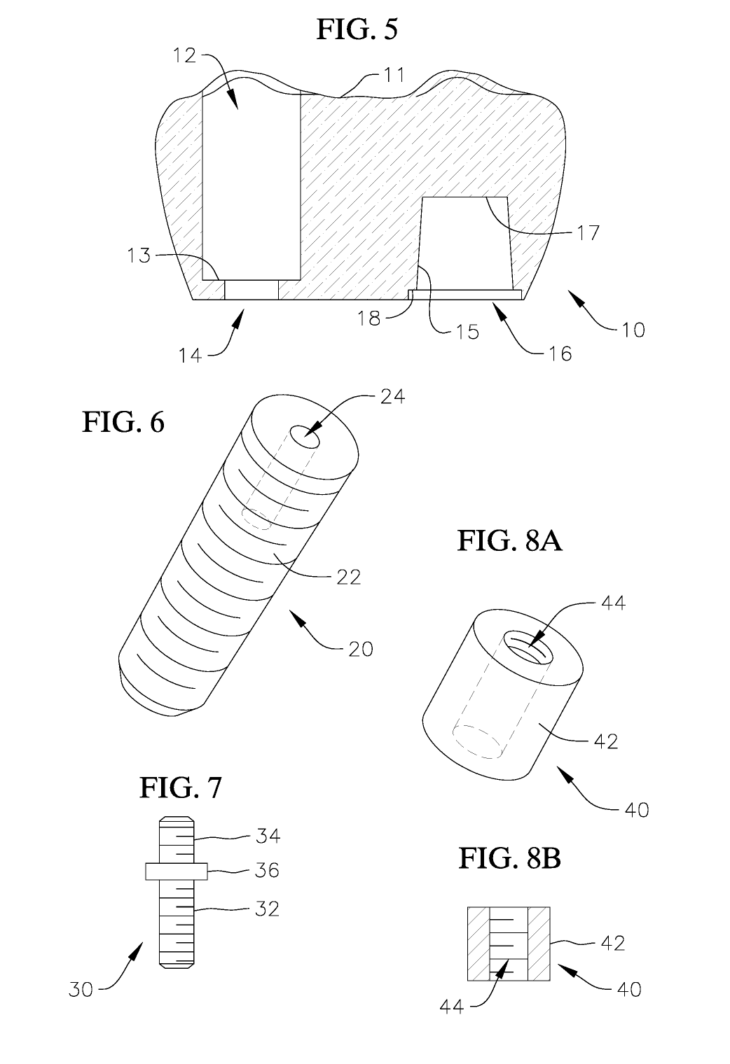

Referring now to FIG. 5, the dental prosthesis 10 includes a body 11 that is generally molded to a desired shape, for example, a shape of the tooth or teeth that the dental prosthesis 10 is intended to replace. In FIG. 5, the dental prosthesis 10 is a monolithic piece that is molded to a shape of the second bicuspid and the first molar missing in the jawline 1000 of FIG. 4A. In the body 11, a first side includes a first bore 12 that is sized and shaped to interact with the first part of the fixation assembly, while a second side includes a second bore 15 that is sized and shaped to interact with the second part of the fixation assembly. The first bore 12 can be aligned with one of the holes 1040 in the jawline, and consequently, one of the teeth being replaced, and the second bore 15 can be aligned with the other one of the holes 1040 in the jawline and the other tooth being replaced. Meanwhile, in other situations where more than two teeth are being replaced, the dental prosthesis 10 may include one or more solid replacement tooth prosthetics that do not include a bore for a fixation assembly, so that not all of the teeth being replaced requires a separate fixation assembly.

The first bore 12 is a substantially cylindrical bore that is open to a top end of the body 11, that is, an end that faces away from the jawbone 1010 after implantation, to provide access to the hole 1040 from the outside after the dental prosthesis 10 has been placed at a desired position at the implant site. At an end opposite the top end of the body 11, an annular shoulder 13 is formed, to define an opening 14 with a diameter that is smaller than a diameter of the first bore 12. The opening 14 with the reduced size is positioned adjacent to the corresponding hole 1040 when the dental prosthesis 10 is positioned properly at the implant site. Depending on the embodiment, the annular shoulder 13 can be formed monolithically with the rest of the prosthesis 10, or can be attached via one or more additional pieces within the first bore 12. In some embodiments, these additional pieces may be made of a biocompatible metal or other material that is stronger or stiffer than a material of the prosthesis 10, to provide for a stronger attachment site when the prosthesis 10 is attached at the implant site.

Meanwhile, the second bore 15 is a closed bore that is only open to one end of the body 11, with an opening 16 that is configured to face the other corresponding hole 1040 when the dental prosthesis 10 is properly positioned at the implant site. In the embodiment shown in FIG. 5, the second bore 15 has a conical or tapered shape that narrows away from the opening 16, and has an opposite closed end 17. The shape of the second bore 15 is configured in size and shape to closely match the abutment 60, to be described in greater detail below. While the second bore 15 in the instant embodiment is illustrated as being generally symmetrical, in some embodiments, the second bore can be arranged asymmetrically, for example, in a slanted conical shape, so that a corresponding slanted abutment will only fit into the second bore in one orientation, in order to provide a way to properly align the dental prosthesis at the implant site. In addition, in the embodiment in FIG. 5, the second bore 15 further includes a shoulder 18 that provides an enlarged bore region at the opening 16. The shoulder may serve as a stop for a corresponding rim of the abutment 60, to limit an amount of insertion of the abutment 60 into the second bore 15. However, in other embodiments, such a shoulder 18 may be omitted or may not be needed.

Referring back to the first part of the fixation assembly corresponding to the first bore 12, FIGS. 6 to 8B show various different components of the dental implant assembly 1 that are configured to interact with the first bore 12 to lock the dental prosthesis 10 at the implant site. FIG. 6 shows the anchoring fixture 20, which is sized and shaped to be securely screwed into one of the holes 1040 that is pre-drilled into the jawbone 1010. The fixture 20 in FIG. 6 has a slightly sloped or tapered outer surface 22 that includes an outer thread. The thread on outer surface 22 should be sized and shaped to effectively lodge and anchor the fixture 20 in the jawbone 1010 or any bone graft material that defines the corresponding hole 1040. In some embodiments, a leading edge of the thread on the outer surface 22 can be a cutting edge (not shown) to more effectively advance the fixture 20 into the jawbone 1010. Meanwhile, in some embodiments, the outer surface of the anchoring fixture can instead be cylindrical, or can be any other shape that can be effectively advanced into and held in the jawbone 1010. At an end opposite a leading tip, the fixture 20 has a generally flat surface. An inner bore 24 is formed in the fixture 20 and extends from the flat surface towards the leading tip. The inner bore 24 is generally cylindrical, and has an inner thread. In other embodiments, the inner bore can be formed in one of various other shapes. In some embodiments, only a proximal end of the inner bore 24 can be otherwise shaped, for example, in a hexagonal or other polygonal shape, to provide an engagement means for a tool. Alternatively, a proximal region of the outer surface 22 can instead have an alternate shape for engagement with a tool.

FIG. 7 shows the male-to-male screw or connector 30 of the first part of the fixation assembly. The male-to-male screw 30 includes an unthreaded central portion 36 that is cylindrical in shape in the illustrated embodiment. Other embodiments of the male-to-male screw may have a central portion that is polygonal or otherwise shaped, for example, so that the central portion 36 provides an engagement region for an advancement tool. Extending away from one side of the central portion 36 is a first threaded shaft 32. The first threaded shaft 32 is sized and shaped for insertion into the inner bore 24 of the fixture 20. Here, the central portion 36 has a greater width than the first threaded shaft 32 in at least one direction, so that the central portion 36 can act as a stop against the generally flat surface of the fixture 20 when the screw 30 is attached to the fixture 20. Extending away from an opposite side of the central portion 36 is a second threaded shaft 34. The second threaded shaft 34 is sized and shaped to interact with the female fixation screw or nut 40, described in greater detail below. In the embodiment of FIG. 7, the second threaded shaft 34 is substantially the same diameter as the first threaded shaft 32, and has a length that is slightly shorter than a length of the first threaded shaft 32. However, in other embodiments, the relative sizes and shapes of the first and second threaded shafts 32, 34 can be selected based on the particular patient and the other parts of the fixation assembly that will be interacting with the screw 30 to hold the dental implant 1 in place.

FIGS. 8A and 8B respectively show perspective and cross-sectional views of the female fixation screw or nut 40 of the first embodiment. The female fixation nut 40 is generally tubular in shape, with a cylindrical outer surface 42 and a cylindrical inner surface 44. The cylindrical inner surface defines a through bore that extends completely through the nut 40 and that forms openings at opposite ends of the nut 40. The cylindrical inner surface 44 is further threaded with an inner thread that is sized and shaped to engage the second threaded shaft 34 of the connector screw 30. In some embodiments, the nut 40 can be interchangeably advanced onto the second threaded shaft 34 of the screw 30 via either of the opposite openings, to simplify use by an end user. In some other embodiments, one opening may include a short variably shaped (e.g., a polygonal shaped) region for engagement with an advancement tool. In other embodiments, one side of the outer surface 42 can instead have a short region that is otherwise shaped to engage a tool, or the entire outer surface can be otherwise shaped. For example, in some embodiments, the outer surface 42 can be hexagonal. Of further note, an outer diameter of the nut 40 is greater than an inner diameter of the shoulder 13 of the dental prosthesis 10, so that and end of the nut 40 will abut against the shoulder 13 when the nut 40 is inserted into the first bore 12.

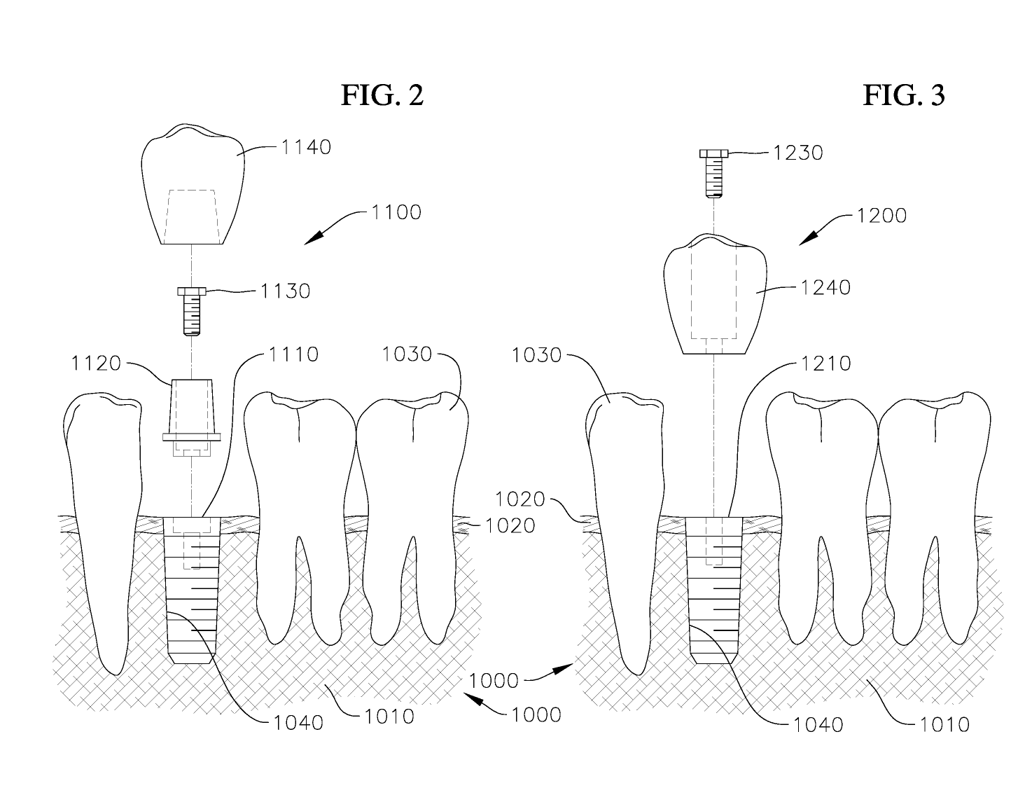

Referring back to FIG. 4B, it shall be noted that the second part of the fixation assembly can be arranged similarly to the cement-based implant described with respect to FIG. 2. However, in the described first embodiment of the dental implant assembly 1, the second part of the fixation assembly may be used for alignment purposes only, rather than for providing additional fixation. As such, in the embodiment shown, fixation of the dental prosthesis 10 to the implant site may only be provided via the first part of the fixation assembly described above, and cement may not be applied between the abutment 60 and the dental prosthesis 10.

Briefly, a second hole 1040 can be sized for insertion of the second anchoring fixture 50. Like the first anchoring fixture 20, the second anchoring fixture 50 can have a slightly conical or tapered outer surface 52 with a bone thread, to facilitate advancement of the fixture 50 into the second hole 1040, or can be otherwise shaped, for example, cylindrically shaped. At an end opposite the leading tip of the fixture 50, a threaded inner bore 54 is formed for interaction with the fixation screw 70. In addition, an enlarged bore region 56 can be formed adjacent the opening to the inner bore 54 to house a first end 62 of the abutment 60. The enlarged bore region 56 can be cylindrical or any other shape, to match the first end 62 of the abutment 60 Meanwhile, the abutment 60 includes the first end 62 sized and shaped to be inserted into the enlarged bore region 56, and a second end 64 that has an outer surface that is conical in shape to match the conical shape of the second bore 15 of the dental prosthesis 10. As discussed above, while the second end 64 in the illustrated embodiment is generally rotationally symmetrical, in other embodiments, the second end can be asymmetrical to facilitate proper alignment of the dental prosthesis 10 at the implant site. In some of these embodiments, the first end of the abutment and the enlarged bore region of the fixture can further be formed asymmetrically, so that a proper or desired orientation of the asymmetrical second end of the abutment can be achieved. Meanwhile, the abutment 60 further includes a generally cylindrical through bore 66 with a shoulder 68 at the first end 62, forming a reduced sized opening at the first end 62. Lastly, the fixation screw 70 has a threaded shaft 72 sized to interlock with the threaded inner bore 54 of the fixture 50, and a head 74 with an outer width that is greater than an inner width of the opening defined by the shoulder 68 of the abutment 60. In practice, the fixture 50 can be securely inserted and anchored in the second hole 1040 at the implant site, the first end 62 of the abutment 60 can be inserted into the enlarged bore region 56 of the fixture 50, and the fixation screw 70 can be inserted through the bore 66 of the abutment and screwed into the threaded inner bore 54 of the fixture 50, while head 74 of the screw 70 abuts against shoulder 68 of the abutment to affix the abutment 60 to the fixture 50.

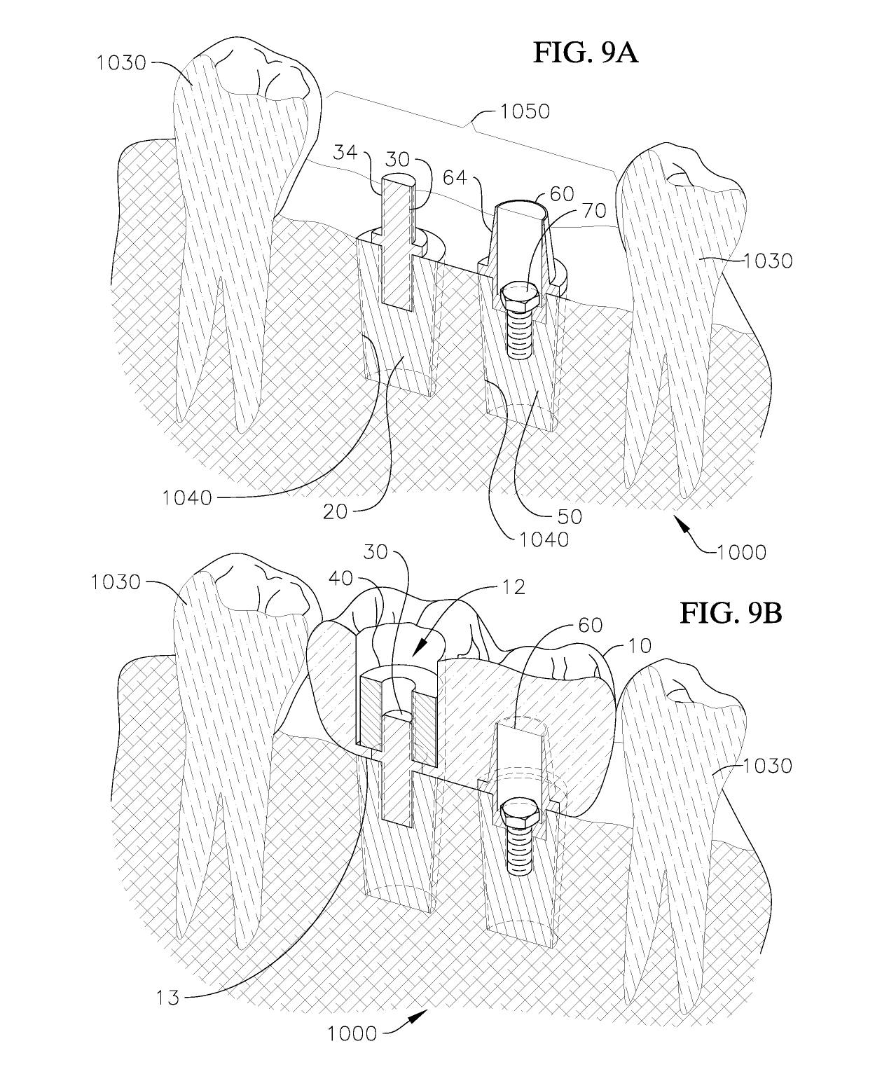

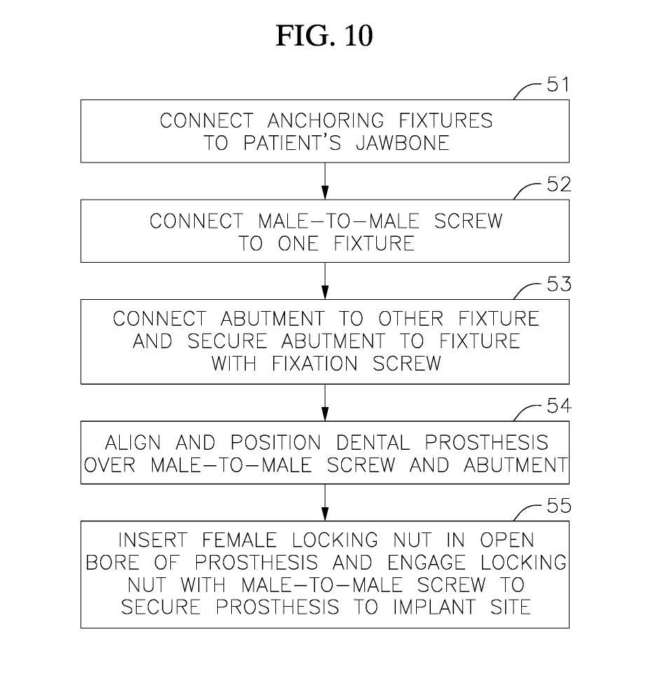

FIG. 10 is a flow chart showing a method of implanting a dental implant assembly according to an embodiment of the invention. The method shown in FIG. 10 can be applied to the first embodiment of the dental implant assembly 1 discussed above, and will be described in greater detail with reference to FIGS. 4B, 9A, and 9B.

Referring first to FIG. 4B, in operation, after appropriately sized holes 1040 have been pre-formed at desired positioned in the patient's jawline, in step S1, the anchoring fixtures 20 and 50 are implanted into the respective holes 1040 and are thereby connected to the patient's jawbone 1010. In some situations, after the fixtures 20, 50 have been implanted in the patient, a healing period may be needed in order for the fixtures 20, 50 to properly set in the patient's jawbone 1010.

Next, referring to FIG. 9A, after the fixtures 20, 50 have been properly set and allowed to heal in the patient's jawbone 1010, in step S2, the male-to-male screw connector 30 is connected to the fixture 20, and in step S3, the abutment 60 is attached to the fixture 50 and affixed to the fixture 50 with the fixation screw 70. It is to be understood that the order of attaching the connector 30 and the abutment 60 can be reversed, so that abutment 60 is attached prior to connector 30, depending on the specific circumstances. FIG. 9A shows a state of the dental implant 1 prior to the dental prosthesis 10 being attached. As can be seen in FIG. 9A, a combination of both the second threaded shaft 34 of the male-to-male connector 30 and the conical second end 64 of the abutment 60 are exposed, so that the dental prosthesis 10 can be placed over these exposed components in only one orientation, reducing the possibility of user error. In addition, the exposed parts are relatively larger than comparable exposed portions of traditional implants, to further ease implantation. Lastly, due to the presence of the locking connector 30 associated with the first part of the fixation assembly, the abutment 60 only need be used for alignment purposes, and the additional use of cement to affix the abutment with the dental prosthesis 10 is therefore not necessary. However, in some embodiments, cement may still be used between abutment 60 and the dental prosthesis 10, for example, in cases where the dental professional determines that additional or supplemental fixation may be beneficial for the patient.

Then, referring to FIG. 9B, in step S4, the dental prosthesis 10 is advanced to and positioned at the implant site. The bore 12 is aligned with the male-to-male connector 30 and the bore 15 is aligned with the abutment 60, to ensure that the dental prosthesis 10 is positioned at the implant site at the desired orientation. Due to the relative dimensions between the bores 12, 15 the connector 30, and the abutment 60, the dental prosthesis 10 cannot be placed at the implant site backwards. In cases with a dental prosthesis having more than two replacement teeth, generally, the various components of the dental implant can still be selected and arranged so that the dental prosthesis fits over the other components at the implant site in only the desired position and orientation.

Thereafter, in step S5, the female locking nut 40 is inserted into the open bore 12 of the dental prosthesis 10 and is screwed over the second threaded shaft 34 of the male-to-male connector 30. The shoulder 13 of the dental implant 10 is pinched between the central portion 36 of the connector and the locking nut 40, so that the dental implant 10 is locked in place at the desired position at the implant site, with no possibility of inadvertent removal or loss. Meanwhile, a tight fit between the second end 64 of the abutment 60 and the bore 15 of the dental prosthesis 10 provides a second support structure to assist in holding the dental prosthesis 10 at a desired orientation, and for example, eliminates the possibility of undesired rotation, wiggling, or other undesirable movements of the dental prosthesis 10 relative to the connector 30. By utilizing the male-to-male connectors 30, a male connection portion is exposed on the jawline during implantation, and a larger female nut 40 can be used for final locking instead of a relatively smaller male locking screw as was the case in traditional procedures. The larger female locking nut 40 will generally be easier to handle and advance, and will be less prone to dropping and loss than male locking screws, so that the final locking process can be performed more easily by the end user.

As noted above, in some embodiments, cement may be applied between abutment 60 and dental prosthesis 10 to increase security of the dental prosthesis 10 at the implant site, but due to the locking via connector 30 and locking nut 40, the additional step of using cement becomes optional. In addition, in some embodiments, the locking nut 40 can be made asymmetrical, or a proximal end of the locking nut 40 can be trimmed or shaved off, so that the proximal end of the locking nut 40 conforms to the shape of the exposed surface of the dental prosthesis 10 in order to provide a more uniform tooth surface, for both aesthetic and functional purposes. In other embodiments, the locking nut 40 may be short enough so that a proximal end of the nut 40 falls below the exposed tooth surface after locking. In some embodiments, an additional step of adding a cap or other filling material, such as a composite material, to fill the open bore 12 after final locking, in order to complete the exposed tooth surface, may further be performed. In this manner, the bore 12 can be filled to match the surrounding surfaces, and can also be molded in a specific shape or manner, for example, to provide for a more effective closure with an opposite tooth surface which comes into contact with the tooth prosthesis when the patient's mouth is closed. By adding such composite or other filler material, the patient can also, for example, chew more effectively with the dental implant or implants, among other benefits.

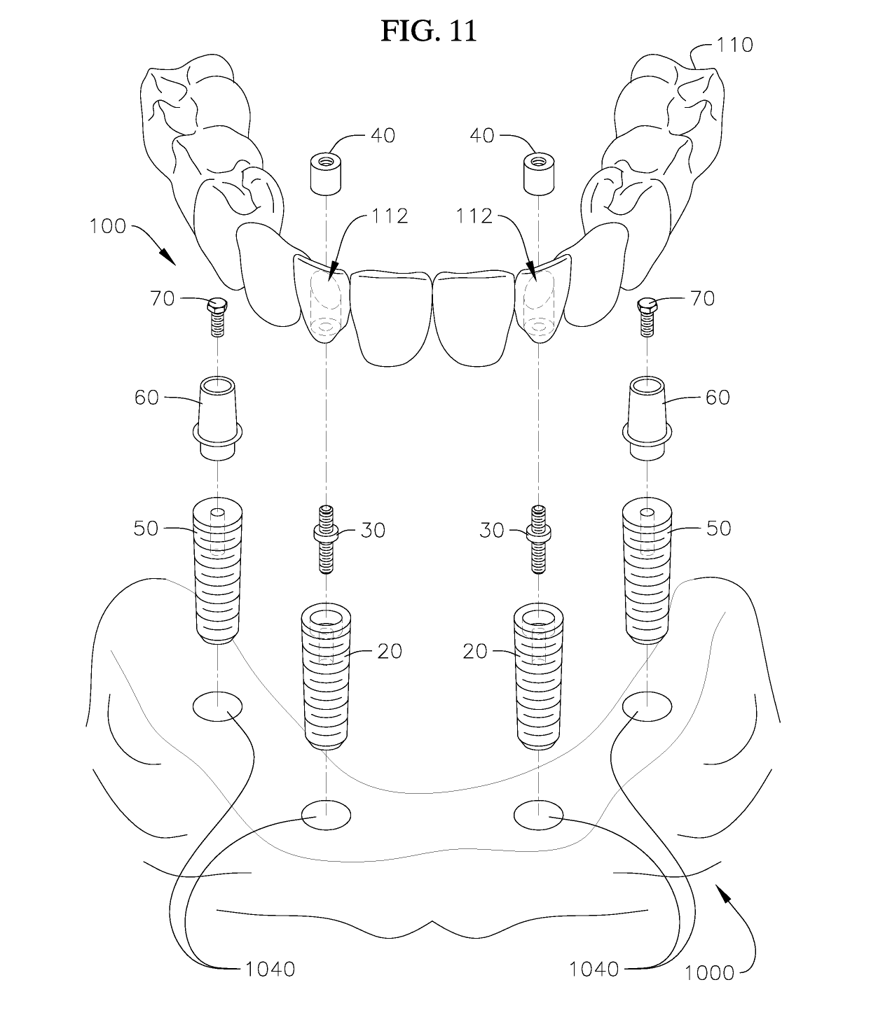

Meanwhile, in some situations, for example, due to disease, lack of care by the patient, or any of various other reasons, most or all of the teeth along a patient's jawline may already be lost or need extraction. In some of these situations, the most feasible approach for tooth replacement may be to remove any remaining natural teeth or remnants thereof, and to replace the entire set of dentition along one or both jaw lines using a full arch dental implant. FIGS. 11 to 13 show a full arch dental implant assembly and replacement process according to a second embodiment of the invention.

The full arch dental implant assembly 100 according to the second embodiment of the invention includes similar components to those discussed above with respect to the dental implant assembly 1 according to the first embodiment of the invention. As such, the same or similar components from the first embodiment have been provided with the same reference numbers, and detailed descriptions thereof will not be repeated. The full arch implant assembly 100 includes a full arch dental prosthesis 110, which is a molded, etched, 3-D printed, or otherwise formed monolithic prosthesis that includes an entire set of replacement teeth for one jaw line 1000. Rather than having a fixation assembly through each replacement tooth in the dental prosthesis 110, many of the replacement teeth are formed as solid replacement tooth prosthetics, while select attachment points are selected for attachment to the patient's jawline. In the illustrated example, four fixation points have been selected, with two fixation assemblies including connectors 30 and locking nuts 40 for locking the dental prosthesis 110 to the jawline 1000, and two abutments 60 to further ensure proper alignment and stability of the dental implant 100 after implantation.

Referring to FIG. 11, the jawline 1000 has been prepared with four pre-drilled holes 1040. Two of the holes 1040 are formed and positioned near a front of the jawline, for example, corresponding to positions of native incisors or cuspids. Two additional holes 1040 are formed and positioned near the rear of the jawline, for example, corresponding to positions of native molars or second bicuspids. In the example shown, the two forward positioned holes 1040 are intended for fixation assemblies including fixtures 20, male-to-male connectors 30, and female locking nuts 40, while the two rear positioned holes 1040 are intended for fixation assemblies including fixtures 50, abutments 60, and fixation screws 70. With such an arrangement, after positioning of the full arch prosthesis 110, additional fixation steps (e.g., final locking using the locking nuts 40) need only be performed near the front of the mouth, which is easier to access by the dental professional.

However, based on the particular needs of the patient, for example, based on the strength of different portions of the jawline, etc., different arrangements of fixation assemblies, in addition to more or less fixation points, may be employed instead in other embodiments. For example, the fixation assemblies with connectors 30 and locking nuts 40 can instead be positioned near the rear of the jaw, or in some embodiments can be positioned near the front of one side of the jawline 1000, and positioned near the rear of the other side of the jawline 1000. In other embodiments, more fixation assemblies including connectors 30 and locking nuts 40 can be used than fixation assemblies including abutments 60, or abutments 60 may not be used altogether. Referring back to the arrangement illustrated in FIG. 11, in some embodiments, the rearward positioned holes 1040 may be angled, for example, towards the front of the jawline 1000, so that the abutments 60 attached thereto are angled towards the front of the mouth. In such embodiments, the full arch prosthesis 110 may be made easier to slide over the abutment during positioning. In other embodiments, the abutments may be otherwise curved or angled, for example, slightly towards the rear of the jawline 1000, so that while it may be a bit more difficult to place the full arch prosthesis 110 thereon, the abutments 60 in these embodiments may provide additional holding force to more effectively hold the entire dental implant assembly 100 in place after implantation.

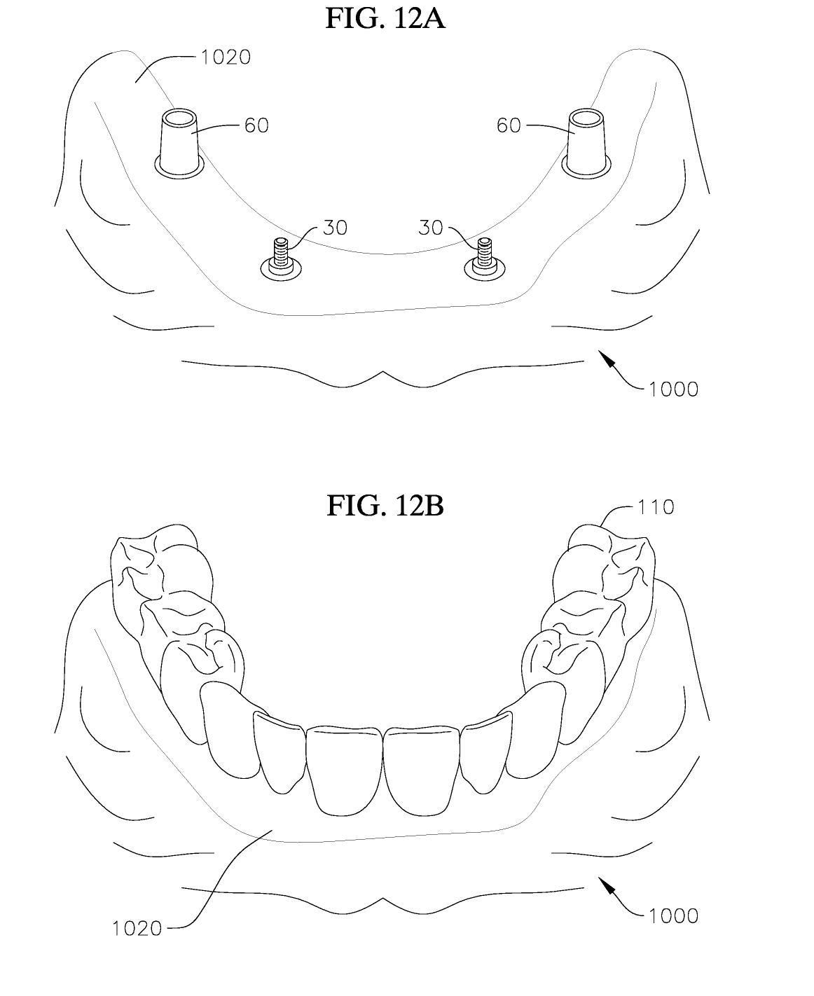

Referring again to FIG. 11, in the illustrated second embodiment, similarly as described with respect to the first embodiment, fixtures 20 are implanted into the jawline 1000 at the corresponding forward positioned holes 1040, and fixtures 50 are implanted into the jawline 1000 at their corresponding rear positioned holes, and then the fixtures 20, 50 are allowed to set and heal. Thereafter, male-to-male connector screws 30 are connected to fixtures 20, and abutments 60 are connected to fixtures 50 with fixation screws 70. FIG. 12A schematically shows the jawline 1000 after connectors 30 and abutments 60 have been properly positioned, and prior to attachment of the full arch prosthesis 110. As can be seen in FIG. 12A, functional portions of each of the connectors 30 and the abutments 60 protrude out of the gingival cavity 1020 and away from the jawline 1000 for engagement with the dental prosthesis 110.

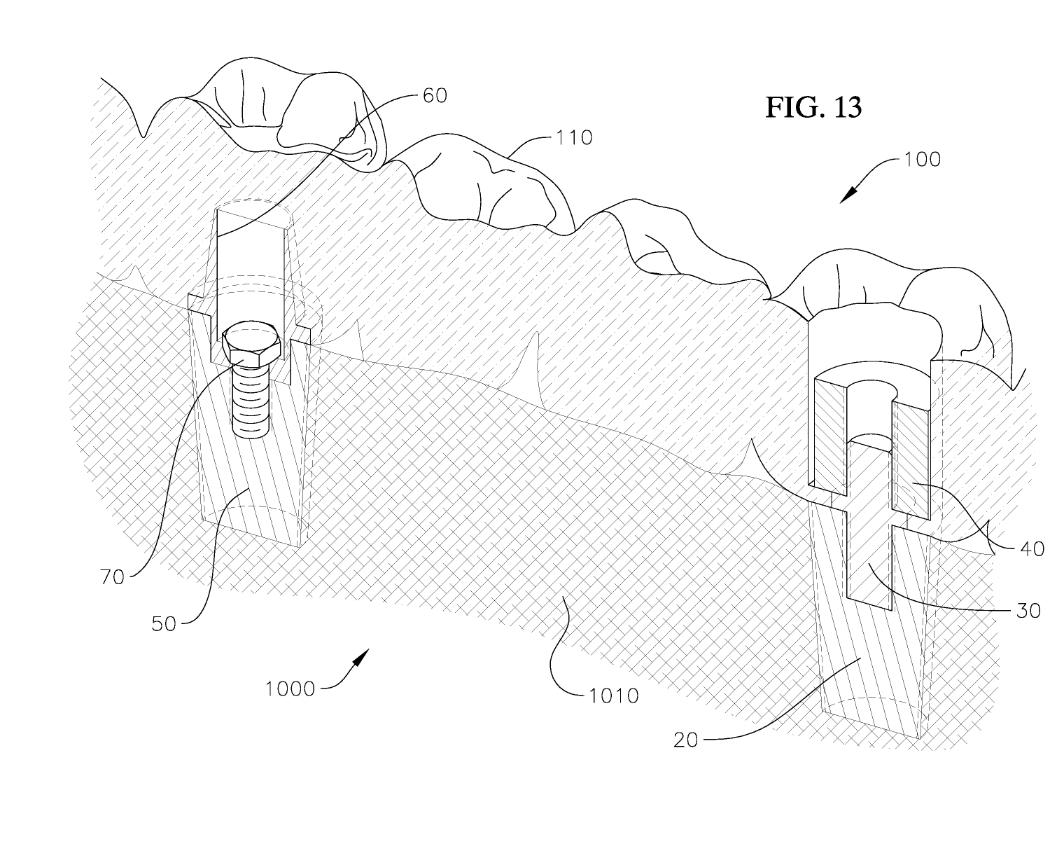

Then in FIG. 12B, the full arch dental prosthesis 110 is attached to the jawline 1000, with the appropriately sized and shaped bores receiving the exposed portions of the connectors 30 and the abutments 60. As an example, bores 112 are shown as being formed through replacement incisors in FIG. 11, so that they will be aligned with the connectors 30 upon implantation. Then, female locking nuts 40 are passed through the bores 112 and are threaded onto the connectors 30, to finally lock the full arch prosthesis 110 in place on the patient's jawline. The combination of the connectors 30 and locking nuts 40, along with the interaction between the prosthesis 110 with the abutments 60, will effectively hold the full arch prosthesis 110 in place. FIG. 13 shows a partial cross-section of FIG. 12B, including cross-sectional views of the monolithic prosthesis 110 and both the fixation assembly including the connector 30 and locking nut 40 and the fixation assembly including the abutment 60. In addition, similarly as discussed with respect to the first embodiments, after the prosthesis 110 is finally locked in place with the locking nut 40, a cap or other composite or other filling material can be used to cover or fill the bore over the locking nut 40.

According to the second embodiment of the invention, a full arch prosthesis 110 can be implanted at a jaw of a patient with minimal parts and fixation points. Traditional full arch implants may incorporate upwards of six, eight, or more fixation points, with a large number of abutments that may be slightly misaligned or intentionally or inadvertently arranged at slight angles, that made it difficult to fit the full arch prosthesis over all of the abutments at the same time. In contrast, with the use of only a few abutments 60, difficulties in advancing and positioning the full arch prosthesis 110 at a desired position at the implant site can be avoided, and the implantation process can thereby be simplified. Meanwhile, in the illustrated example, only two female locking nuts 40 are used to sufficiently lock the full arch prosthesis 110 after placement of the prosthesis 110. The reduced number of locking nuts 40 used to lock the dental implant assembly 100 in place also serves to simplify the final implantation procedure, and the large profile of the locking nuts 40, for example, when compared to traditional male locking screws, eases handling during final locking and helps prevent inadvertent loss of parts, thereby reducing the possibility of complications during implantation.

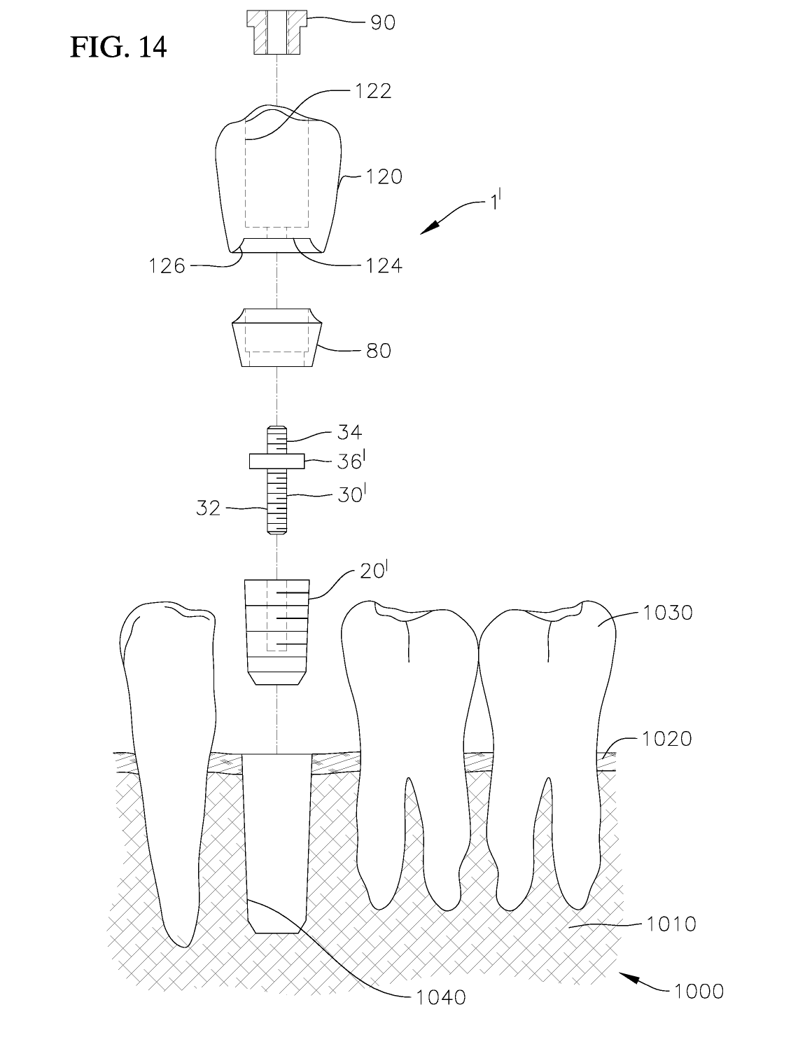

FIG. 14 shows a cross-sectional view of a lower jawline with one tooth missing or extracted, and a cross-sectional exploded view of a single tooth dental implant assembly according to a third embodiment of the invention. The dental implant assembly 1′ according to the third embodiment employs a male-to-male connection screw 30′ that is similar to the male-to-male connection screw 30 discussed with respect to the first two embodiments, but with additional modifications, discussed in greater detail below. As such, parts that are the same or similar to those in the first two embodiments will include the same reference numbers, and detailed descriptions thereof will be omitted.

In FIG. 14, the dental implant assembly includes an anchoring fixture 20′, a male-to-male connector or screw 30′, an adapter 80, a single tooth dental prosthesis 120, and a female locking nut or screw 90. Compared to previously described embodiments, the adapter 80 is a new component that can be used to provide easier advancement and positioning of the dental prosthesis 120 at the desired implant site. Meanwhile, the anchoring fixture 20′, the male-to-male connector 30′, the dental prosthesis 120, and the locking nut 90 can each be slightly modified to accommodate and properly interface with the adapter 80, to securely lock the dental prosthesis 120 in place at the implant site.

The anchoring fixture 20′ is similar to the anchoring fixture 20 described above in the first two embodiments. However, a flat proximal surface of the fixture 20′ will be implanted to a greater depth in the hole 1040 of the jawbone 1010 than the fixture 20 was implanted in the previous embodiments. As such, in the illustrated embodiment, the fixture 20′ has been formed to be slightly shorter than the fixture 20. In other embodiments, the hole 1040 can be pre-drilled to a greater depth, or the fixture 20′ can be otherwise advanced to a greater depth into the jawbone 1010.

The male-to-male connector 30′ includes a first threaded shaft 32 and a second threaded shaft 34 that may be constructed similarly to the threaded shafts 32, 34 of the male-to-male connector 30. However, the central portion 36′ may be constructed slightly differently. In the illustrated embodiment, the central portion 36′ has a height that is greater than a height of the central portion 36. In addition, the central portion 36′ may have, for example, a polygonal cross-section, such as a square cross-section, or other non-cylindrical cross-section, to rotationally lock against a complementarily shaped bore in the adapter 80, to be described in greater detail below. In some embodiments, additional engagement features may also be present on central portion 36′ or other parts of the connector 30′, or for example, at the proximal end of the fixture 20′, for engagement with the adapter 80, so that when the adapter is connected to the fixture 20′ and the connector 30′, the three respective parts can be held together securely prior to the dental prosthesis 120 being locked thereto.

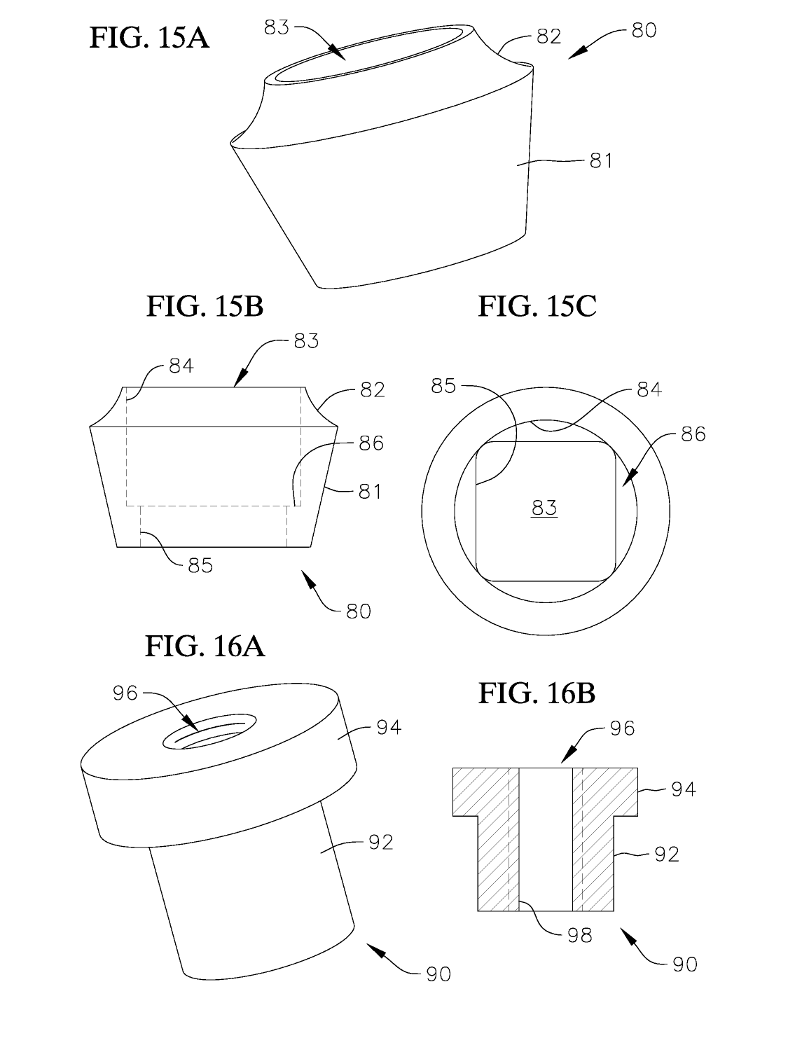

Referring now to FIGS. 15A to 15C, the adapter 80 includes a first part 81 that is configured to be arranged distally and adjacent to the fixture 20′ upon implantation. An outer surface of the first part 81 of the adapter 80 can be slightly conical or tapered, narrowing towards a free end of the adapter 80. In other embodiments, the first part 81 may be cylindrical or otherwise shaped. A second part 82 extends from a proximal end of the first part 81 and is configured to be arranged proximally and away from the fixture 20′ upon implantation. The second part 82 also narrows away from the first part 81 towards an opposite free end of the adapter 80. In the embodiment shown, the second part 82 is slightly curved with a concave curvature, but the adapter 80 should not be limited thereto. In other embodiments, the second part 82 can, for example, be tapered with a substantially flat surface, or can be convexly curved. In other embodiments, for example, the first part 81 can also have a curved surface. In addition, the second part 82 will generally have a height that is shorter than a height of the first part 81. Here, the second part 82 is tapered in a manner such that the adapter 80 does not have to be aligned perfectly when implanted at the implant site. The slight taper in all radial directions of the surface of the second part 82 allows for an easy connection surface against which a dental prosthesis (e.g., a bottom side of prosthesis 120) can rest, even if the adapter 80 is tilted slightly to one side at the implant site. While under ideal circumstances, a straight adapter 80 is desirable to provide for an easy connection with the dental prosthesis later, the surface of the second part 82 still establishes and provides the practitioner with an easy implant site to work with, even if the adapter 80 is tilted, so that further adjustments of the anchoring fixture 20′, the connector 30′, or the adapter 80 should not be needed for effectively attaching the dental prosthesis thereto.

At the free end corresponding to the second part 82, the adapter 80 defines an opening 83, and a first bore 84 that extends from the opening 83. The first bore 84 is cylindrical, and the opening 83 is circular. Meanwhile, a second bore 85 extends between the bore 84 and the opposite free end corresponding to the first part 81 of the adapter 80. The second bore 85 has at least a portion with a reduced width compared to the first bore 84, forming a shoulder 86 in the adapter 80. In addition, the second bore 85 can have a polygonal or other non-cylindrical shaped cross-section. As can be seen in FIG. 15C, the second bore 85 in this embodiment has a square cross-section, which can closely match the square cross-section of the central portion 36′ of the male-to-male connector 30′.

Referring briefly back to FIG. 14, the dental prosthesis 120 includes a through bore 122 that can be similar in structure to the through bore 12 of the dental prosthesis 10 of the first embodiment, and a shoulder 124 that can be similar in size and shape to the shoulder 13 of the dental prosthesis 10. It is to be noted that the shoulder 124 can be made integrally or monolithically with the rest of the dental prosthesis 120, such that the shoulder is formed directly in the prosthesis 120. In some other embodiments, the through bore 122 can include one or more features that interact with one or more additional biocompatible metal nuts or other components that can be affixed inside the through bore 122, where the shoulder 124 is formed on one or more of the additional components, instead of directly on the prosthesis 120. Such an arrangement can, for example, provide a stronger or more robust connection region when the prosthesis 120 is attached at the implant site, and/or can provide for a more versatile implant, for example, such that the prosthesis 120 can be fitted with appropriate additional pieces having a particular shape or structure based, for example, on the specific patient and/or procedure. Meanwhile, a bottom or distal surface 126 of the dental prosthesis 120 that is configured to contact the second part 82 of the adapter 80 can include surface features, for example, a protruding rim, with an inner surface that closely matches the outer surface of the second part 82, to allow for easier alignment between the components during assembly, and also so that a contact area between the adapter 80 and the dental prosthesis 120 can be increased to provide a more secure connection therebetween when the components are assembled together. In embodiments where additional attachment pieces are utilized, the distal surface 126 can, for example, be constructed from one of variously shaped pieces, to provide for a more modular or versatile implant kit.

Lastly, referring to FIGS. 16A and 16B, the female locking nut 90 has been modified for use with the adapter 80 and the dental prosthesis 120. The locking nut 90 has a first portion 92 with a generally cylindrical outer surface. The first portion 92 is configured to be arranged distally towards the male-to-male connector 30′ when the locking nut 90 is assembled thereto. An enlarged second portion 94 is attached proximally to the first portion 92. The enlarged second portion 94 has an outer width that is greater than an outer width of the first portion 92 in at least one radial direction. Additionally, the first portion 92 of the locking nut 90 has a width or diameter that is smaller than both a smallest inner width of the opening defined by shoulder 124 of dental implant 120 and a smallest inner width of the second bore 85 of the adapter 80, so that the first portion 92 of the locking nut 90 can reach and engage the connector 30′. Meanwhile, the enlarged second portion 94 of the locking nut 90 has at least a part that has a greater width than the smallest inner width of the opening defined by the shoulder 124 of dental implant 120, so that the second portion 94 abuts against the shoulder 124 when the locking nut 90 is advanced through the bore 122 of the dental prosthesis 120. In some embodiments, an outer surface of the second portion 94 is polygonal or otherwise non-cylindrically shaped, or has an engagement feature, to more effectively engage an advancement tool. It is also to be understood that, while locking nut 90 is described with an enlarged second portion 94, locking nuts in other embodiments may not have such an enlarged second portion 94, and may instead have a single uniform outer surface. In such embodiments, either the locking nut or the dental prosthesis, or another part of the dental implant assembly, may include one or more additional features that will serve to hold the components together upon tightening of the locking nut and final locking of the implantation of those dental implant assemblies.

Meanwhile, the locking nut 90 has a generally cylindrical inner through bore 96 that has openings at both ends of the locking nut 90, and an inner wall 98 that is threaded and sized to engage the threads of the second threaded shaft 34 of the connector 30′. In some embodiments where the outer surface of the second portion 94 of the locking nut 90 is cylindrical, a proximal region of the through bore 96 may instead define a polygonal or otherwise non-cylindrically shaped surface, or have a further engagement feature, to engage an advancement tool. In other embodiments, the inner bore of the locking nut may be a closed bore that is only open to the distal end (i.e., the end corresponding to the first portion 92) for engagement with the connector 30′, and an additional tool engagement recess can be provided at the proximal end corresponding to the second portion 94 of the locking nut 90.

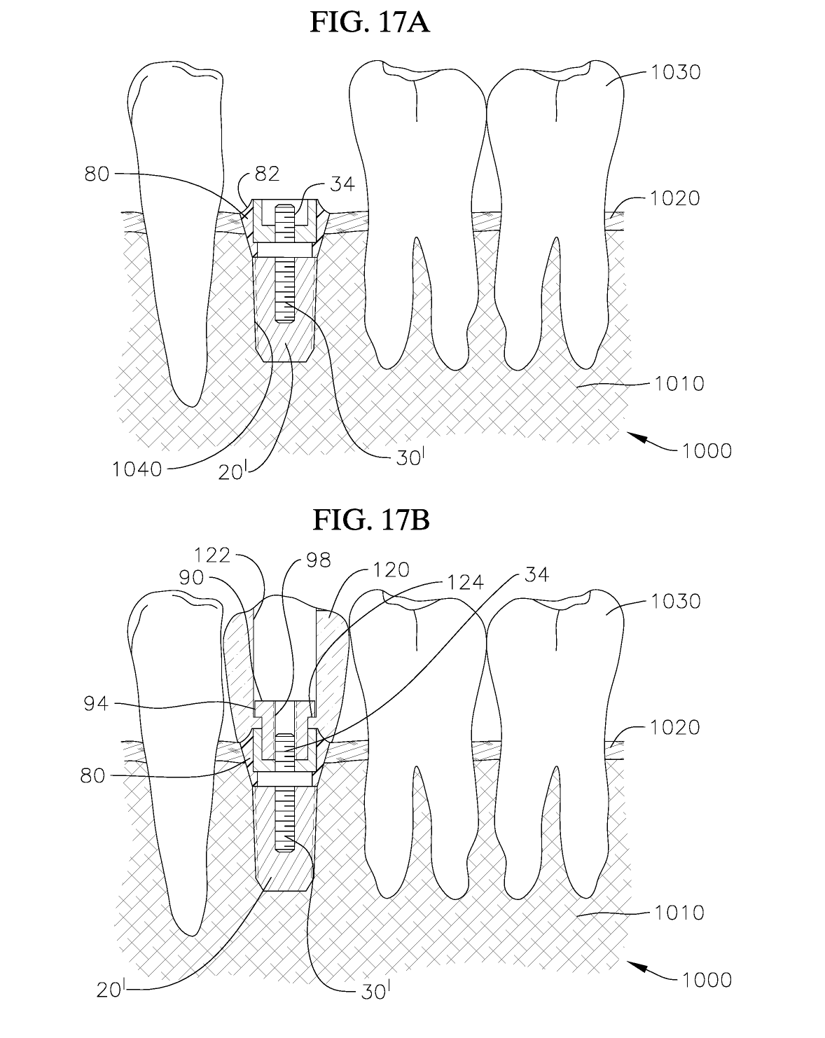

Referring now to FIGS. 14 and 17A, after a hole 1040 is pre-drilled to a desired size and shape in the jawbone 1010 of the patient's jaw 1000, the anchoring fixture 20′ is advanced into the hole 1040, to a depth where a proximal end of the fixture 20′ is positioned deeper than the surface of the gingival tissue 1020 and the surface of the jawbone 1010. A height difference between the exposed surface of the gingival tissue 1020 and the proximal end of the fixture 20′ can correspond substantially to the height of the first part 81 of the adapter 80, so that the second part 82 of the adapter 80 will later protrude slightly from the exposed surface of the gingival tissue 1020. Then, the first threaded shaft 32 of the connector 30′ is connected to the fixture 20′, such that the central portion 36′ and the second threaded shaft 34 protrude therefrom. At this point, the proximal free end of the connector 30′ corresponding to an end of the second threaded shaft 34 may still be positioned below the exposed surface of the gingival tissue 1020, so that no part of the connector 30′ extends outside of the hole 1040, or the proximal free end of the connector 30′ may protrude only slightly therefrom.

Then, the adapter 80 is inserted into the hole 1040, so that the distal end of the adapter 80 abuts against the proximal face of the fixture 20′. At this position, the second part 82 of the adapter 80 may protrude slightly from the gingival tissue 1020, as seen in FIG. 17A, so that vision of and access to the second part 82 is easy for the practitioner or other end user after the adapter 80 is implanted and prior to attachment of the dental prosthesis 120. The adapter 80 can be affixed to the fixture 20′ and/or the connector 30′ in one or more of various methods. In some embodiments, the shape of the central portion 36′ of the connector 30′ matches the shape of the second bore 85 of the adapter 80 (e.g., square in the illustrated embodiment), and the inner profile of the central portion 36′ can be slightly smaller than the outer profile of the adapter 80, such that the adapter 80 can be attached to the connector 30′ in a press-fit manner. In other embodiments, either the central portion 36′ or other part of the connector 30′ and/or a proximal end of the fixture 20′ can include one or more engagement features that interact with complementary engagement features on the adapter 80, to securely hold the pieces together. In yet other embodiments, an adhesive or other external attachment means can be used between the components to keep them held together prior to fixation of the dental prosthesis 120.

After implantation of the fixture 20′, the connector 30′ and the adapter 80, the patient can be allowed to heal, and the respective components can be allowed to set in the jaw 1000. As can be seen in FIG. 17A, in this intermediate position, the adapter 80 generally surrounds and protects the second threaded shaft 34 of the connector 30′, so that the gingival tissue 1020 will not heal over the connector 30′. The first bore 84 of the adapter 80 further provides an accommodation space around the second threaded shaft 34 of the connector 30′, to provide unobstructed access for the locking nut 90 during implantation of the dental prosthesis 120. In addition, while the second part 82 of the adapter protrudes out of the gingival tissue 1020, the amount and height of protrusion is very small compared to both the male-to-male connectors 30 and the abutments 60 seen in previous embodiments. In this manner, a dental prosthesis can be placed over the adapter 80 from an increased range of positions and angles, allowing for more flexibility for the practitioner or other end user during placement of the dental prosthesis 120. For example, the practitioner has the flexibility of sliding the dental prosthesis 120 in this embodiment into place from the side, rather than requiring placement of the dental implant 120 at the implant site from above. The angled outer surface of the second part 82 also facilitates easier and more flexible advancement of the dental prosthesis 120 onto the adapter 80 during positioning of the dental prosthesis 120, while the slightly curved surfaces provide for an easy way to locate a correct positioning between the components (e.g., when the complementary surfaces 82, 126 are properly pressed or fitted against one another). In addition, although not pictured, similarly as described above, the slightly tapered surface of the second part 82 allows for the dental prosthesis 120 to be attached later, even if the adapter 80 is slightly angled, tilted, or not perfectly aligned with the other components in the dental implant. For example, if the adapter 80 is tilted to one side, the tapered surface will still generally remain flush and provide a generally flat surface for the dental prosthesis to rest upon. In addition, because of the generally flat projecting portion of the adapter 80, regardless of whether the adapter 80 is slightly tilted, the practitioner has the flexibility to advance the dental prosthesis to the implant site at one of various different angles, further simplifying the implant procedure. To this effect, in some embodiments, rather than the dental prosthesis 120 having a particularly shaped distal surface 126 that matches with a shape of the second part 82 of the adapter 80, the distal surface 126 of the prosthesis 120 may instead be made generally flat, so that it does not have to perfectly align with the adapter 80 in order to attach the respective pieces to one another.

Then, referring to FIG. 17B, the dental prosthesis 120 is placed over the implant 80, and the locking nut 90 is advanced through the bore 122 and is rotated to engage the second threaded shaft 34 of the connector 30′. Here, the shoulder 124 in the bore 122 of the dental prosthesis 120 is pinched between the enlarged second portion 94 of the locking nut 90 and the adapter 80 to lock the dental prosthesis 120 against the adapter 80, and to finally affix the dental prosthesis 120 at the implant site. In some embodiments, an additional cap or composite or other filling material can then be added to cover or fill the bore 122, and/or a proximal end of the locking nut 90 can be shaped to match an exposed surface of the dental prosthesis 120 surrounding the bore 122.

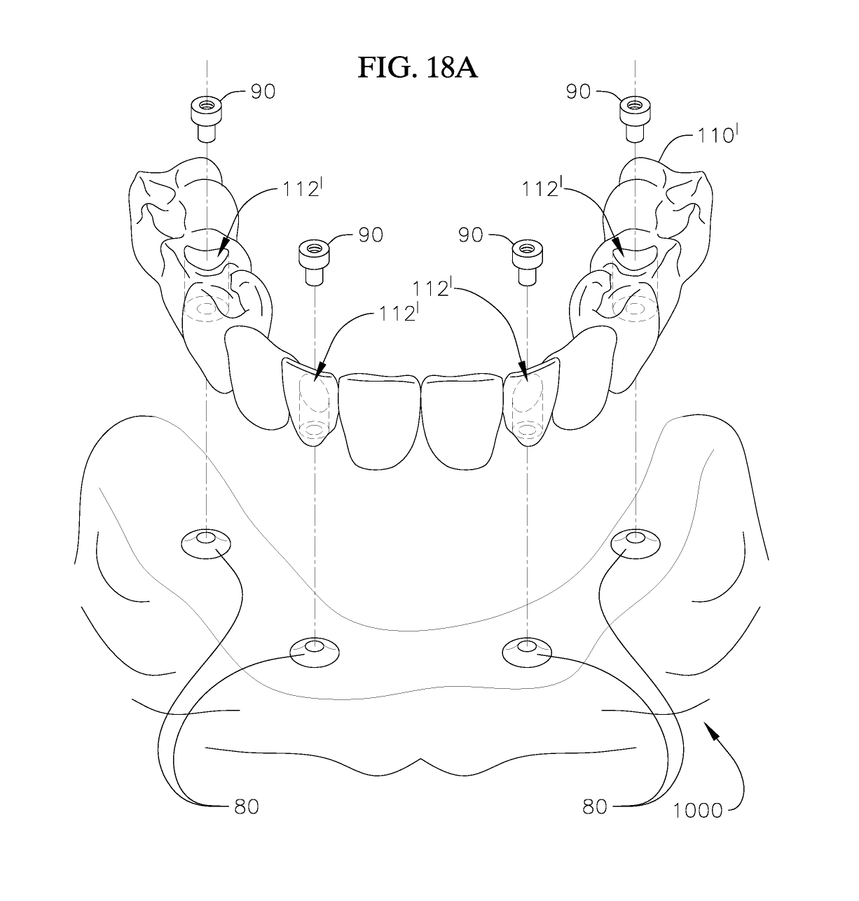

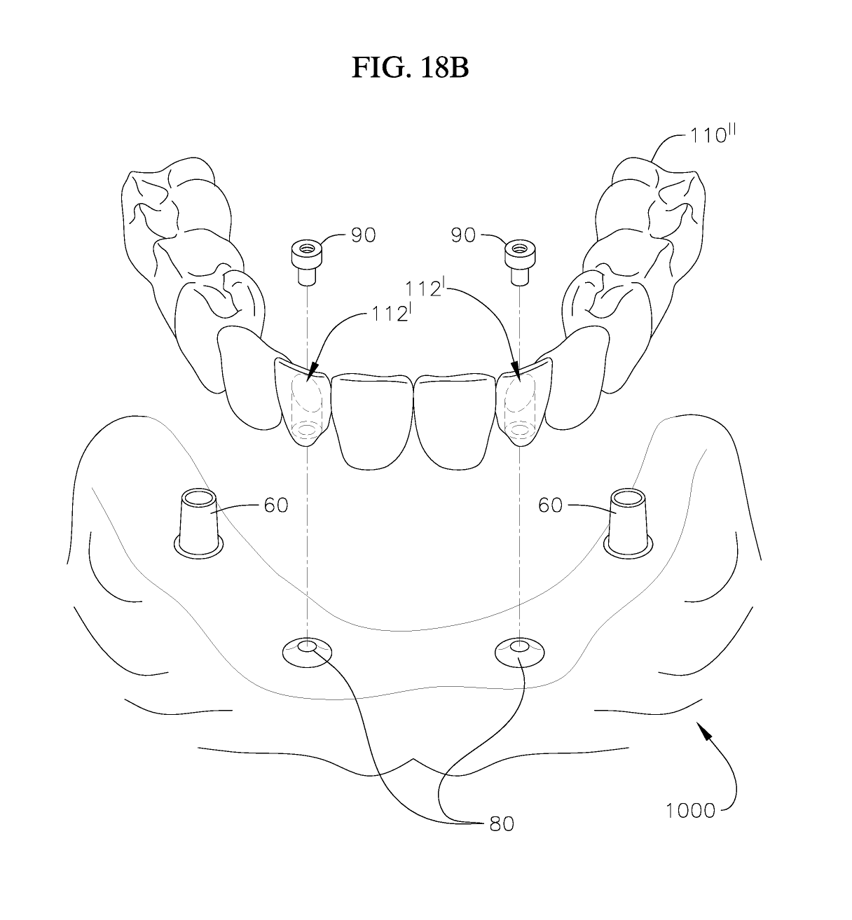

FIGS. 18A and 18B respectively show two further embodiments where adapters 80 like those described with respect to the third embodiment are applied to full arch dental implant assemblies in two different ways, in order to facilitate easier implantation of a full arch dental prosthesis. Parts and/or features that are the same or similar to parts and features of the previous embodiments will be identified with the same reference numbers, and detailed descriptions thereof will not be repeated.

First, with reference to FIG. 18A, a full arch dental prosthesis 110′ has been modified with four through bores 112′ at select positions to correspond to attachment with four fixation assemblies using adapters 80. The holes 1040 and corresponding fixation assemblies can be positioned similarly to those described with respect to the full arch dental implant assembly in FIGS. 11 to 13, or in other embodiments, can be placed at positions corresponding to one or more different natural teeth, depending on the circumstances and the condition of each patient. Here, four fixation assemblies including four adapters 80 have already been implanted in the patient's jaw 1000. As can be seen, the adapters 80 protrude minimally from the jaw 1000, in order to make it easier to advance the full arch dental implant 110′ to the implant site, and to correctly position the dental implant 110′ in a desired position and orientation at the implant site. The full arch dental implant 110′ is then positioned on the jaw 1000 so that the bores 112′ are each aligned with respective ones of the adapters 80, and then respective locking nuts 90 are advanced into the bores 112′ to engage the connectors 30′ (not shown) positioned in each of the adapters 80 to lock the full arch prosthesis 110′ in place.

In the embodiment shown in FIG. 18A, since only the small second parts 82 of the adapters 80 are protruding from the jaw 1000 prior to attachment of the full arch prosthesis 110′, the full arch prosthesis 110′ can be placed on the jaw 1000 from one of a variety of positions and angles, providing the practitioner or other end user with wide flexibility when initially placing the prosthesis 110′ into position. Furthermore, even if one or more of the adapters 80 is not perfectly aligned to provide a vertical connection with the dental implant 110′, the implant procedure does not need to be compromised or delayed, because the second parts 82 of the adapters are slightly tapered, such that even at a slight angle, the adapters 80 still provide a generally flat surface on which the dental implant 110′ can rest. Thereafter, tightening of the dental implant 110′ against the adapters 80 will cause the respective pieces to align.

However, one potential drawback of this arrangement is that once the prosthesis 110′ is advanced to the implant site at a desired position and orientation, it may be difficult to hold the prosthesis 110′ at that desired position when the locking nuts 90 are being applied, due to the lack of any significant protruding pieces which can temporarily hold the prosthesis 110′ in place during final tightening and fixation.

In a modified embodiment shown in FIG. 18B, the two rear positioned fixation assemblies have been replaced with abutment fixation assemblies, so that two abutments 60 project from the jaw 1000 prior to placement of the full arch prosthesis. The full arch prosthesis 110″ has further been modified in this embodiment, so that the two rear bores are sized and shaped to accommodate the abutments 60. Here, although it may be slightly more difficult to initially place the full arch prosthesis 110″ into the desired position (e.g., the abutments 60 will require downward placement of the prosthesis 110″ thereon), the presence of the abutments 60 will serve to temporarily hold the full arch prosthesis 110″ in place during final tightening of the two locking nuts 90, for example, by restricting rotation or lateral sliding of the implant. In some embodiments, similarly as discussed with respect to previous embodiments, the abutments can also be asymmetrical or arranged at an angle relative to the jaw 1000, for example, to ease placement and/or to increase a hold of the dental prosthesis 110″ against the jaw 1000. Furthermore, in this example, a smaller number of locking nuts 90 are used, further simplifying the final fixation process. Lastly, since adapters 80 are still used for the two forward positioned attachment points, similarly as discussed with respect to the previous embodiments, attachment at these sites is made easier due to the tapered surfaces of the second parts 82 allowing for easier connections even when the adapters 80 may be slightly tilted or angled. This flexibility is especially helpful in this embodiment, due to the restrictions in positioning caused by the abutments 60.

The dental prostheses of the embodiments described above can therefore be affixed and finally implanted at desired implant sites using a reduced number of final fixation steps. The parts are also enlarged, to reduce the possibility of loss of parts and/or other complications during the implantation process. In some embodiments, advancement of the dental prostheses themselves to the implant sites prior to final fixation can also be more easily achieved. Furthermore, in the embodiments of the invention described above, since the final fixation process has generally been simplified with a reduced number of locking screws or nuts that can be selected to be positioned at more easily accessible positions, in situations where removal, repositioning, and/or replacement of the dental prosthesis becomes necessary, the locking nuts can also be more easily accessed for removal of and/or adjustments to the dental prostheses even after final implantation. Therefore, embodiments of the invention provide for improved implant assemblies, as well as improved installation and removal processes.

In other embodiments, the different fixation assemblies may be rearranged or positioned at different regions in each patient's upper or lower jaw, depending for example, on the particular situation and condition of the patient. In some other embodiments, more or less fixation assemblies in various combinations and arrangements can also be used, depending for example, on the desired implant size, position, and the condition of the patient. It is to be further understood that the different features of the various different embodiments of the invention described above are interchangeable and can be combined to form other embodiments of the invention. It is also to be understood that features of the embodiments can also be applied to dental implant assemblies for replacing a patient's teeth for any of a number of different sized edentulous spaces. For example, the features can be applied to four-tooth prosthetics, half arch prosthetics, and any other size prosthetics, without deviating from the inventive features of the invention.

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalents thereof.

What is claimed is:

1. A dental implant assembly comprising:
a first fixation assembly comprising:
a male-to-male connector; and
a female locking nut;
a second fixation assembly comprising an abutment; and
a dental prosthesis having a first bore sized to receive the female locking nut and a second bore sized to receive the abutment;
wherein at one end of the first bore, the dental prosthesis comprises a shoulder defining an opening, wherein a first threaded portion of the male-to-male connector is configured to fit through the opening, and wherein an outer width of the female locking nut is greater than an inner width of the opening, such that the shoulder is configured to be locked between the first threaded portion and the female locking nut when the first threaded portion is passed through the opening into the first bore and the female locking nut engages the first threaded portion.

2. The dental implant assembly of claim 1, wherein the first fixation assembly further comprises an anchoring fixture configured to engage a second threaded portion of the male-to-male connector.

3. The dental implant assembly of claim 1, wherein the abutment comprises a first end having a conical or otherwise tapered outer surface.

4. The dental implant assembly of claim 3, wherein the first end of the abutment is asymmetric about a central axis of the abutment.

5. The dental implant assembly of claim 3, wherein the second fixation assembly further comprises an anchoring fixture configured to engage an opposite second end of the abutment, and a fixation screw configured to lock the abutment to the second fixation assembly.

6. The dental implant assembly of claim 1, wherein the dental prosthesis is configured to replace a plurality of teeth.

7. The dental implant assembly of claim 1, wherein the dental prosthesis comprises a full arch prosthesis, and wherein bores for fixation assemblies are formed in only some of the replacement teeth of the full arch prosthesis.

8. A method of implanting a dental implant assembly comprising a first fixation assembly comprising a male-to-male connector and a female locking nut configured to engage a first threaded portion of the male-to-male connector, a second fixation assembly comprising an abutment, and a dental prosthesis having a first bore configured to engage the male-to-male connector and sized to receive the female locking nut and a second bore sized to receive the abutment, the method comprising:
implanting the male-to-male connector at a first position of an implant site;
implanting the abutment at a second position of the implant site;
positioning the dental prosthesis at the implant site such that the first bore is aligned with the male-to-male connector and the second bore is aligned with the abutment;
inserting the female locking nut into the first bore and engaging the female locking nut with the first threaded portion of the male-to-male connector for locking the dental prosthesis at the implant site.

9. The method of claim 8, further comprising implanting a first anchoring fixture at the first position of the implant site, and implanting a second anchoring fixture at the second position of the implant site, wherein the male-to-male connector is connected to the first anchoring fixture, and the abutment is connected to the second anchoring fixture with a fixation screw.

10. The method of claim 9, further comprising respectively preparing first and second holes at the first and second positions of the implant site prior to respectively implanting the first and second anchoring fixtures into the first and second holes.

11. The method of claim 10, wherein a central axis of the second hole is arranged at an angle relative to a central axis of the first hole.

12. The method of claim 8, further comprising applying cement or other adhesive between the abutment and the second bore of the dental prosthesis.

13. The method of claim 8, wherein the dental prosthesis comprises a full arch prosthesis, and wherein at least two male-to-male connectors and two corresponding female locking nuts are used to lock the full arch prosthesis at the implant site.

14. A dental implant assembly comprising:
an anchoring fixture for anchoring to a jawbone of a patient;
a male-to-male connector having a first threaded portion configured to connect to the anchoring fixture and a second threaded portion;
an adapter separable from the anchoring fixture, wherein when the anchoring fixture, the male-to-male connector, and the adapter are connected to one another, the adapter extends circumferentially around the second threaded portion of the male-to-male connector in a radial direction with a radial gap therebetween;
a dental prosthesis defining a bore; and
a female locking nut insertable into the bore of the dental prosthesis and configured to extend into the radial gap to engage the second threaded portion of the male-to-male connector.

15. The dental implant assembly of claim 14, wherein the adapter defines an inner bore with a first portion having a non-circular cross-section, and the male-to-male connector comprises a central portion between the first and second threaded portions having an outer surface with cross-section having a shape that matches a shape of the first portion of the inner bore of the adapter.

16. The dental implant assembly of claim 14, wherein when the anchoring fixture, the male-to-male connector, and the adapter are connected to one another, the adapter comprises a first outer surface that faces away from the anchoring fixture, wherein the first outer surface tapers and narrows in a direction away from the anchoring fixture, and wherein when the anchoring fixture, the male-to-male connector, and the adapter are implanted at the implant site, the first outer surface is the only portion of the assembly that is configured to be exposed to the outside.

17. The dental implant assembly of claim 16, wherein the dental prosthesis comprises a distal surface configured to contact the first outer surface of the adapter, and wherein the distal surface is sized and shaped to match the first outer surface.

18. The dental implant assembly of claim 14, wherein the female locking nut comprises a first outer surface and a second outer surface that has a greater width than the first outer surface, wherein the second outer surface is configured to engage a shoulder in the dental prosthesis to hold the dental prosthesis against the adapter when the dental implant assembly is assembled and locked together.

19. The dental implant assembly of claim 14, wherein the dental prosthesis comprises a full arch prosthesis, and wherein at least anchoring fixtures, at least two male-to-male connectors, at least two adapters, and at least two female locking nuts are used to lock the full arch prosthesis at an implant site.

20. The dental implant assembly of claim 14, wherein the dental prosthesis comprises a full arch prosthesis, and wherein the dental implant assembly further comprises an abutment to facilitate proper alignment of the full arch prosthesis at an implant site.
